(19) United States
(12) Patent Application Publication
(10) Pub. No.: US 2017/0084084 A1
(43) Pub. Date: Mar. 23, 2017

(54) MAPPING OF USER INTERACTION WITHIN A VIRTUAL REALITY ENVIRONMENT

(71) Applicant: Thrillbox, Inc, Austin, TX (US)

(72) Inventors: Benjamin T. Durham, Austin, TX (US); Mike Love, Austin, TX (US); Jackson J. Egan, Austin, TX (US); Andrew J. Lintz, Austin, TX (US)

(21) Appl. No.: 15/272,210

(22) Filed: Sep. 21, 2016

Related U.S. Application Data
(60) Provisional application No. 62/303,992, filed on Mar. 4, 2016.
(60) Provisional application No. 62/222,062, filed on Sep. 22, 2015.

(51) Int. Cl. G06T 19/00; G06F 3/01

(52) U.S. Cl. CPC G06T 19/006; G06F 3/013

(57) ABSTRACT

Method for tracking a user's gaze within a virtual-reality environment comprises generating a user coordinate system within a virtual space. The user coordinate system is associated with a virtual sphere surrounding a location of a camera within the virtual space. The method also includes generating a hotspot within the virtual space. The hotspot comprises a hotspot coordinate associated with a virtual object and a pre-defined threshold of space surrounding the virtual object. Additionally, the method includes accessing view information, received from one or more sensors integrated within an end user virtual-reality hardware device. The view information relates to the direction of the user's gaze within the real-world. Further, the method includes mapping the view information to the user coordinate system. Further still, the method includes determining, based upon the mapping, whether the user's gaze intersected with the hotspot.

### CROSS-REFERENCE TO RELATED APPLICATIONS

This application claims the benefit of and priority to, U.S. Provisional Application Ser. No. 62/303,992, filed on Mar. 4, 2016, entitled “MAPPING OF USER INTERACTION WITHIN A VIRTUAL-REALITY ENVIRONMENT,” and to U.S. Provisional Application Ser. No. 62/222,062, filed on Sep. 22, 2015, entitled “MAPPING OF USER INTERACTION WITHIN A VIRTUAL-REALITY ENVIRONMENT.” The entire content of each referenced application is incorporated by reference herein in its entirety.

### BACKGROUND OF THE INVENTION

Recent advances in virtual reality technology and the accompanying decrease in virtual reality equipment cost has introduced consumer-friendly virtual reality to the mass market. For example, advancements in virtual reality technology have resulted in growing popularity of virtual reality embodiments amongst smartphone owners, who are now capable of using their smartphone devices as virtual reality head mounted displays. The widespread use of virtual reality introduces several new technical challenges. These technical challenges range from increasing bandwidth to mobile devices to the construction of useful virtual-reality environments.

Accordingly, significant improvements to the field of virtual reality and tracking of virtual reality content are needed.

### BRIEF SUMMARY OF THE INVENTION

Embodiments disclosed herein include a computer system for tracking a user's gaze within a virtual-reality environment. The computer system includes computer-executable instructions that when executed configure the computer system to perform various actions. For example, the system generates a virtual-reality environment coordinate system within a virtual space. The system also generates a hotspot within the virtual space, wherein the hotspot comprises a hotspot coordinate associated with a virtual object and a pre-defined threshold of space surrounding the virtual object. Additionally, the system accesses view information, received from one or more sensors integrated within an end user virtual reality hardware device. The view information relates to the direction of the user's gaze within the real-world. Further, the system maps the view information to the environment coordinate system. Further still, the system determines, based upon the mapping, whether the user's gaze included the hotspot.

Disclosed embodiments also include a method for tracking a user's visual focus within a virtual-reality environment. The method includes generating a user coordinate system within a virtual space. The user coordinate system is associated with a virtual sphere surrounding a location of a camera within the virtual space. Additionally, the method includes generating a hotspot within the virtual space. The hotspot comprises a hotspot coordinate associated with a virtual object and a pre-defined threshold of space surrounding the virtual object. The method also includes accessing view information, received from one or more sensors integrated within an end user virtual reality hardware device. The view information relates to the direction of the user's gaze within the real-world. Further, the method includes mapping the view information to the user coordinate system. Further still, the method includes determining, based upon the mapping, whether the user's gaze intersected with the hotspot.

Additional disclosed embodiments also include a computer system for tracking a user's gaze within a virtual-reality environment. The computer system includes computer-executable instructions that when executed configure the computer system to perform various actions. For example, the system generates a user coordinate system within a virtual space. The user coordinate system is associated with a virtual sphere surrounding a location of a camera within the virtual space. The system also generates a hotspot within the virtual space. The hotspot comprises a hotspot coordinate associated with a virtual object and a pre-defined threshold of space surrounding the virtual object. Additionally, the system accesses view information, received from one or more sensors integrated within an end user virtual reality hardware device. The view information relates to the direction of the user's gaze within the real-world. The system further maps the view information to the user coordinate system. The system also determines, based upon the mapping, whether the user's gaze intersected with the hotspot.

Additional features and advantages of exemplary embodiments of the invention will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic of an embodiment of a virtual reality platform.

FIG. 2 illustrates a schematic of an embodiment of a spherical data acquisition system.

FIG. 3 illustrates a schematic of an embodiment of a virtual reality data acquisition system.

FIG. 4 illustrates a diagram depicting an embodiment of a virtual reality processing method.

FIG. 5 illustrates a diagram depicting another embodiment of a virtual reality processing method.

FIG. 6 depicts a user interface for a data acquisition system for a virtual-reality environment.

FIG. 7 illustrates a flowchart for an embodiment of a method for tracking a user's gaze within a virtual-reality environment.

### DETAILED DESCRIPTION OF THE PREFERRED EMBODIMENTS

Disclosed embodiments extend to systems, and methods, and apparatus configured to track a user's interactions within a virtual-reality environment. In particular, disclosed embodiments comprise end-user virtual-reality equipment and software components that determine whether a user visually gazes at a particular virtual element within the virtual reality environment. Instead of merely rendering a virtual three-dimensional world, tracking a user's visual interactions within the virtual reality world provides significant benefits within the art.

Accordingly, disclosed embodiments provide a virtual-reality system component that can track a user's interaction with the virtual-reality environment. For example, the system determines whether a user has looked at a particular rendered object within the virtual three-dimensional environment and how long the user looked at the rendered object. In at least one embodiment, this can be of particular value because a viewer may only actually look at a small portion of a total rendered scene. For example, when viewing a three-dimensional movie, a viewer may only be gazing at less than 20% of a given frame. As data relating to multiple users' interactions with the virtual three-dimensional environment is gathered, trends and patterns can be identified. Additionally, placement of objects of importance within the virtual three-dimensional environment can be optimized.

With advancements in antenna technology and internet accessibility, the ability to stream graphically intensive virtual reality content to internet connected smartphones is increasing and may soon become ubiquitous. As virtual-reality use becomes more mainstream it will be desirable to acquire data relating to user engagement within virtual-reality environments like spherical video or virtual reality video games that are accessed with internet connected smartphone devices. The desired data may include the user turning his head, how long the user looks at a particular object in a scene, how the user uses peripheral input devices (or voice) to interact with the displayed content, how long the user is engaged by the particular piece of content, and other similar information.

In various embodiments of the present invention, an end user may include the human user of a virtual-reality system along with the accompanying end-user data and end-user behavior data. The end-user data may comprise identifying information associated with the end user (also referred to herein in as “user”), while the end-user behavior data may comprise information relating to the user's specific actions within a virtual-reality environment. For example, the end-user data may comprise an identification variable that identifies the end user within the virtual-reality system. In contrast, the end-user behavior data may comprise information relating to the end user's view within the virtual reality system, head position, eye focus location, button clicks, and other similar interactive data.

In at least one embodiment, the present invention provides significant privacy benefits as well. For example, embodiments of the present invention only track gaze and coordinate systems. As such, no data is actually gathered relating to what the user does within the virtual-reality environment, what the user sees, or any other context specific data about the virtual-reality environment. All of the data of interest may be tracked via the gaze vectors and coordinate system.

Additionally, in at least one embodiment, the end-user data comprises identification data that does not include a user's name or email address. For example, at least one disclosed embodiment, generates an audience ID that is an aggregate of information about the end user that comes from connecting their social media account information (from opting in to “share” experiences on social media), with the proprietary data that is collected by disclosed embodiments. The collected data includes immersive behavioral data, as well as human authored and assigned meta data for objects of interest within immersive media content.

As at least one disclosed embodiment, makes no calls for the UDID, UUID, or advertisingIdentifier (“AD-ID”) of the device when it is downloaded from app distribution platforms. Additionally, disclosed embodiments may generate an Immersive Behavioral ID (IBID) that is a log of end user's engagement with and within immersive media content. In at least one embodiment, a designer is able to create hotspots and assign meta data to objects of interest identified within a virtual-reality environment. The designer can also associate AD-ID's or calls for specific ad units that will be placed by mobile ad platforms, which in turn generate data with regard to how the user interacts with the ad (e.g., was it viewable? did they click on it? etc.). Some disclosed embodiments then correlate these sets of data to determine where and what an end user was looking at within a virtual-reality environment. This type of immersive behavioral data is a unique identifier for every user. The aggregate of information from the Immersive Behavorial Identifier (“IBID”), user interaction with the AD-ID tagged ad unit, transactional information, as well as social media user information constitute the “Audience ID”.

While virtual-reality systems can comprise a wide variety of different embodiments, in at least one embodiment the end-user virtual reality hardware comprises a computer system with components like but not limited to: (i) CPU, GPU, RAM, hard drive, etc., (ii) head mounted display (dedicated or non-dedicated mobile device display), (iii) input devices, such as keyboard, mouse, game controllers, or microphone, (iv) haptic devices & sensors, such as touch pads, (v) positional sensors, such as gyroscope, accelerometer, magnetometer, (vi) communication relay systems such as near field communication, radio frequency, Wi-Fi, mobile cellular, broadband, etc., and (vii) device operating system & software to operate a virtual player that simulates 3D virtual-reality environments. Additionally, as used herein, virtual-reality includes immersive virtual reality, augmented reality, mixed-reality, blended reality, and any other similar systems.

Additionally, as used herein, a “virtual player” may be comprised of software to operate virtual-reality environments. Exemplary virtual software can include but is not limited to a spherical video player or a rendering engine that is configured to render three-dimensional images. A “virtual-reality environment” may comprise digital media data like spherical video, standard video, photo images, computer generated images, audio information, haptic feedback, and other virtual aspects. “Virtual elements” may be comprised of digital simulations of objects, items, hotspots, calls, and functions for graphical display, auditory stimulation, and haptic feedback.

In various disclosed embodiments, it may be desirable to utilize a coordinal system within the virtual-reality environment. As such, an analytics engine can generate a virtual reality environment coordinate system within the virtual space (i.e., “virtual-reality environment”). At least one embodiment of the coordinal systems may be comprised of both a gaze coordinate and a virtual position coordinate. The gaze coordinate is comprised of a coordinate system (X, Y), distance (D), and time (t1, t2). X is defined as the latitudinal value, and Y is defined as the longitudinal value. D is defined as the distance value of the viewer (also referred to herein as an “end user”) from a virtual element in a 3D virtual-reality environment. T1 is defined as the virtual time, while T2 is defined as the real time. In at least one additional or alternative embodiment, the gaze coordinate system also comprises a spherical coordinate system that maps to a virtual sphere constructed around the virtual head of a user within the virtual-reality environment.

The virtual position coordinate may be comprised of Cartesian coordinate system X, Y, Z, T1, & T2. X is defined as the abscissa value, while Y is defined as the ordinate value. Additionally, Z is defined as the applicate value. T1 is defined as the virtual time, and T2 is defined as the actual real time. In at least one embodiment, various mathematical transforms can be used to associate the coordinate systems. Accordingly, a coordinal system is disclosed that provides a mathematical framework for tracking a viewer's gaze and position within a virtual-reality environment.

In addition to tracking the relative location of an end user within the virtual-reality environment, disclosed embodiments are configurable to track the relative location of an object of interest within the virtual-reality environment. In at least one embodiment, such objects of interest are tracked by designating a “hotspot” within the virtual-reality environment. The hotspot is associated with the relative location of the item of interest within the virtual-reality environment. At least one embodiment of a “hotspot” comprises one or more virtual elements assigned a value of importance and a hotspot coordinate location assigned to the one or more virtual elements. Additionally, a hotspot may be associated with a pre-defined threshold radius that defines to the size of the hotspot with respect to the target object of interest. For example, a large radius may be associated with a large or highly apparent object. Due to the size of visibility of the item, it is assumed that if the user gazes to any point within the large radius, the user saw the item. In contrast, a small radius may be assigned with a small or less visible object. For example, a specific word may be associated with a small radius. Due to the size and visibility of this object, unless the user gazes nearly directly at the object, it is assumed that the user did not see the item.

In at least one embodiment, a user interface is provided that allows a user to easily select an item of interest within a virtual-reality environment and create hotspot. For example, a tablet or smart phone may be used to play a spherical video. While the video is not being displayed within an immersive headset, the video is responsive to the user moving the smart phone or tablet around. As such, a user is able to view the entirety of the spherical video from the screen of the device.

During playback of the video, the user can identify an object of interest, pause the video, and select the object through the touch screen. The user is then provided with options for selecting the size of the radius associated with the hotspot and associating metadata with the hotspot. The hotspot information is then uploaded to a client server for use. As such, another user who views the video and gazes at the hotspot will be logged as having seen the hotspot.

Further, in at least one embodiment, when creating a hotspot the user is also able to associate commands or options with the hotspot. For example, the user may create a hotspot around a particular can of soda. The user may then create a command option for purchasing the soda. In this case, when a future user gazes at the soda can, an option is presented to the user for purchasing the can of soda.

The disclosed embodiments for creating hotspots allow a user to create hotspots from within the spherical video itself, in contrast to creating hotspots from an equireactangular asset that represents the virtual-reality environment. Creating the hotspot within the virtual-reality environment improves the precision associated with the location of the hotspot because it is not necessary to perform a conversion between an equireactangular asset and the virtual-reality environment.

When determining an end user's interaction with an object of interest (as defined by a hotspot) within a virtual-reality environment, disclosed embodiments determine if the end user looks at or gazes at a particular object. In at least one embodiment, tracking the end user's gaze comprises generating a computer-generated reticle (visible or invisible), which is positioned relative to the measure of the coordinate system. The reticle comprises an orientation vector that extends from the middle of the user's field of view within the virtual-reality environment. The computer-generated reticle responds to input devices/sensors controlled by an end user. For example, as the user's view changes within the virtual-reality environment, the reticle also moves.

In at least one embodiment, a software object is associated with a user's location within the virtual-reality environment. For example, Table 1 displayed below, depicts exemplary source code for tracking a user's location and gaze within the virtual-reality environment. In particular, the exemplary source code includes a Cartesian coordinate for the position of the camera within the virtual-reality environment. The camera location is equivalent to the location of the user's view with respect to the coordinate system of the virtual-reality environment. In at least one embodiment, within a rendered virtual-reality environment, the software object tracks a user's relative position within the virtual-reality environment and orientation. The user's position and orientation are used to map hotspots within the virtual-reality environment to the user's view using the method described herein.

Additionally, the exemplary source code includes both a spherical (“spherical”) and a Cartesian (“Cartesian”) coordinate set that describe the point where the reticle intersects with the virtual sphere drawn around the user's head within the virtual-reality environment. In at least one embodiment, both the spherical coordinate set and the Cartesian coordinate set are continually updated in parallel. In various situations it may be mathematically and/or computationally beneficial to use one coordinate set over the other.

TABLE 1

″camera″: {
″x″: 1.2246467991473533e-20,
″y″: 2,
″z″: 0
},
″spherical″: {
″radius″: 0.599634859818729,
″phi″: 0.5390110462966391,
″lambda″: 3.141592653589793
},
″cartesian″: {
″x″: -0.30778508182364134,
″y″: 2,
″z″: 0.514616661716895
},

Similarly, in at least one embodiment, a software object can be associated with a hotspot's location within the virtual-reality environment. For example, Table 2 displayed below, depicts exemplary source code for tracking the location of a hotspot within a spherical video. In particular, the exemplary source code includes a radius of the hotspot, a start time associated with the hotspot, an end time associated within the hotspot, and a Cartesian coordinate with respect to the coordinate system of the virtual-reality environment for the center of the hotspot.

TABLE 2

″radius″: 0.09,
″mediaStartTime″: 0,
″mediaEndTime″: 197.312,
″_id″: ObjectID(″568c40c67db000a1219b0893″),
″center″: {
″cartesian″: {
″y″: 0.08861184,
″x″: 0.4114619,
″z″: 0.426574
}}

The radius of the hotspot defines a viewing area around the hotspot that will determine whether the hotspot was viewed by a user. For example, the radius may comprise a few inches within the virtual-reality environment. In this case, the reticle associated with the user's gaze must align with the few inches in order to be considered a view of the hotspot. In contrast, the radius may be defined to be much larger—several feet—within the virtual-reality environment. In this case, the reticle would only need to align within the several feet of the hotspot to be considered a view of the hotspot. By way of example, in at least one embodiment, small items or written words are associated with small radii to assure that the viewer actually focused on the small item or written words. In contrast, large items, such as cars or houses, have large radii with the assumption that if the user's reticle points within the large radii the user saw the large item.

Additionally, the radius can also provide information regarding what draws a user's gaze to the hotspot itself. For example, the system may detect a user gazing in a first direction. The system may further detect that at least a portion of the hotspot is within the user's peripheral vision. The system can then determine whether, upon seeing the hotspot within his or her peripheral vision, the user's gaze is drawn to the hotspot.

The start time and end time associated with the hotspot may indicate a relative time within a spherical video that the hotspot appears. In the case of a rendered virtual-reality environment, it may not be necessary to track a start or end time, but instead a coordinate location of the hotspot may be continually updated. In either case, the software object may comprise a tracking feature that tracks the hotspot in time and/or space.

While the hotspot described in Table 2 and the user location described in Table 1 are associated with a Cartesian and/or spherical coordinate systems, in various alternate or additional embodiments, any coherent coordinate system may be used. Additionally, as depicted in Table 1, multiple coordinate systems can be used to track a single object (e.g., the user or the hotspot) such that the most efficient coordinate system for a particular function is available for use on a case-by-case basis.

An additional example of a coordinate system is depicted in Table 3 below. In the depicted exemplary coordinate system, the coordinate system maps to a spherical and/or Cartesian point in three-dimensional space relative to the current origin, which is the user's position within the system. The coordinate system can also comprise time logs for both real and environment time. As such, the exemplary coordinate system can track a user within the virtual physical space and temporally through a virtual-reality environment, such as a three-dimensional video.

TABLE 3

```
{
  ″date″: ″2016-03-04T19:13:34.610Z″,
  ″mediaTime″: 132.1386666666667,
    ″cartesian″: {
      x: -3.69205e-11,
      y: 0.01982164,
      z: -0.5996016
    },
  ″spherical″: {
      r: 21.044585411734,
      d: 179.9460118735,
      t: 91.632690320742
    }
}
```

Accordingly, disclosed embodiments of the present invention comprise a data acquisition system that relays end-user data, end-user behavior data, hotspot data, and point of attention/focus data recorded for analysis to produce reports of end user engagement and behavior within a virtual-reality environment. As such, embodiments of the present invention provide a system that tracks an end user's behavior within a virtual-reality environment. The tracked behavior includes the end user's interaction with elements of interest within the environment, including whether the end user gazes at the elements.

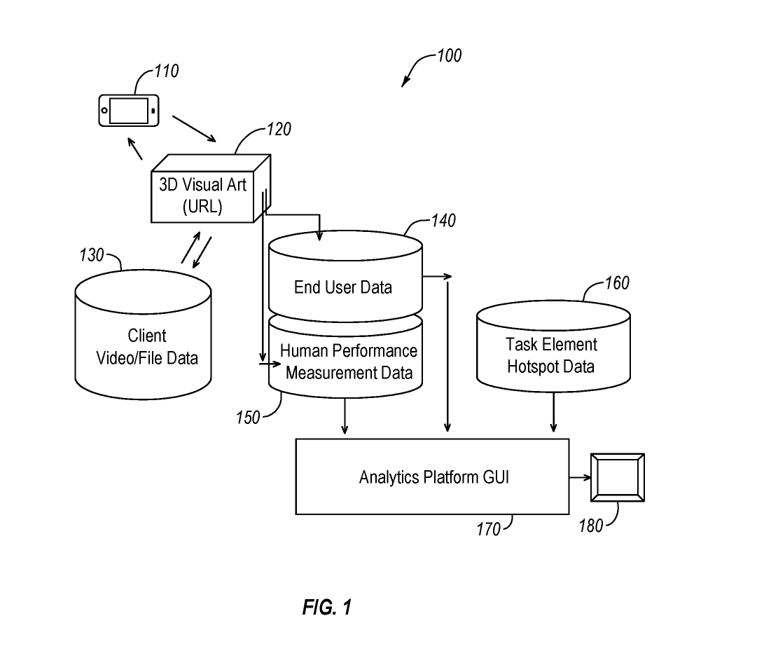

Turning now to the figures, FIG. 1 illustrates a schematic of an embodiment of a virtual-reality platform 100. In particular, FIG. 1 depicts end-user virtual reality hardware that comprises a smart phone 110. In at least one embodiment, the smart phone 110 may be inserted into a mask or headset such that it is positioned directly in front of the end user's eyes. The smart phone 110 may function as a split display with each respective portion of the display providing an image to a respective eye. Each respective image comprises a different perspective of a particular view such that the user is provided with a three-dimensional visual experience.

At least one embodiment comprises accessing a universal resource location (URL) in order to initiate the virtual-reality environment 120. The virtual-reality environment 120 accesses an external database 130 that comprises client videos/file data. The external database 130 is accessible through a network connection, such as the Internet. The external database 130 may comprise a spherical video for use within the virtual-reality environment. The external database 130 may also, or instead, comprise a computer generated three-dimensional environment that is displayed to the user.

At least one embodiment of the present invention comprises an analytics platform interface 170. The analytics platform interface 170 further comprises a plugin that can be incorporated into a wide variety of different virtual-reality systems and/or environments. For example, the plugin may function to gather behavioral data from a spherical video virtual-reality environment or from a computer generated virtual-reality environment.

In at least one embodiment, the analytics platform interface 170 receives information relating to end-user data 140 and human behavioral data (also referred to herein as “human performance measurement data” 150). The end-user data 140 comprises end-user identification information, end-user demographic information, and other information relating to the end user. The human performance measurement data 150 comprises information relating to the end user's interaction with the virtual-reality environment. For example, the human performance measurement data 150 may comprise information relating to the end user's movements, head position, button clicks, and other information relating to user-initiated actions.

The analytics platform interface 170 provides a user interface for analyzing and gathering information from within a virtual-reality environment. For example, it may be desirable to identify how a user interacted within a particular virtual element or object within the virtual-reality environment. The information of interest may comprise whether the end user looked at the virtual element, how long the end user looked at the virtual element, how many times the end user looked at the virtual element, and other similar data.

In at least one embodiment, a virtual element within the virtual-reality environment is associated with or defined by a hotspot. The hotspot is defined as the virtual location of the element within the virtual-reality environment or as a virtual location possessing functionality, including but not limited to executable commands, such as linking to URLs, Media, transactions, surveys, etc. within a virtual-reality environment. In particular, the hotspot can be defined with respect to a coordinate plane within the virtual-reality environment. Various different hotspots may be present within a virtual-reality environment and may be defined by information within a task element/hotspot data database 160. The analytics platform interface 170 determines when an end-user looks at the element (also referred to herein as the “item of interest” or “object of interest”), how long the end-user looks at the element, and other similar data. This information is used to generate a report 180 that details that user's interaction within the virtual-reality environment.

In at least one embodiment, a hotspot can also be associated with metadata that further provides information about the virtual-reality environment. For example, a hotspot may surround a particular brand of candy bar that an advertiser has placed within the virtual-reality environment. The hotspot for the candy bar may be associated with metadata describing who is holding the candy bar, the color of the candy bar, any music playing within the virtual-reality environment, and other similar information. As such, the metadata can comprise both static information and dynamic information that changes based upon events within the virtual-reality environment. When a user views the hotspot, the analytics platform interface 170 receives both an indication that the hotspot was viewed and the metadata associated with the hotspot.

Additionally, in at least one embodiment, a hotspot is associated with a call-to-action function. For example, the analytics platform interface 170 also provides an API that allows various third-parties to integrate functionalities into the virtual-reality environment with respect to a particular hotspot. For example, upon detecting that a user has viewed a hotspot for a threshold amount of time, the analytics platform interface 170 can display a call-to-action function through the API. A call-to-action function may comprise, for example, a visual drop-down menu with options to purchase a product displayed within the hotspot or to learn more about the product. The options may be selectable through user controlled input devices, such as a keyboard or mouse, or through tracking the user's gaze within the virtual-reality environment. Accordingly, in at least one embodiment, third parties can both define hotspots within a virtual-reality environment, and through the above disclosed API, define functions within the virtual-reality environment that can be performed based upon the user's interaction with the hotspots.

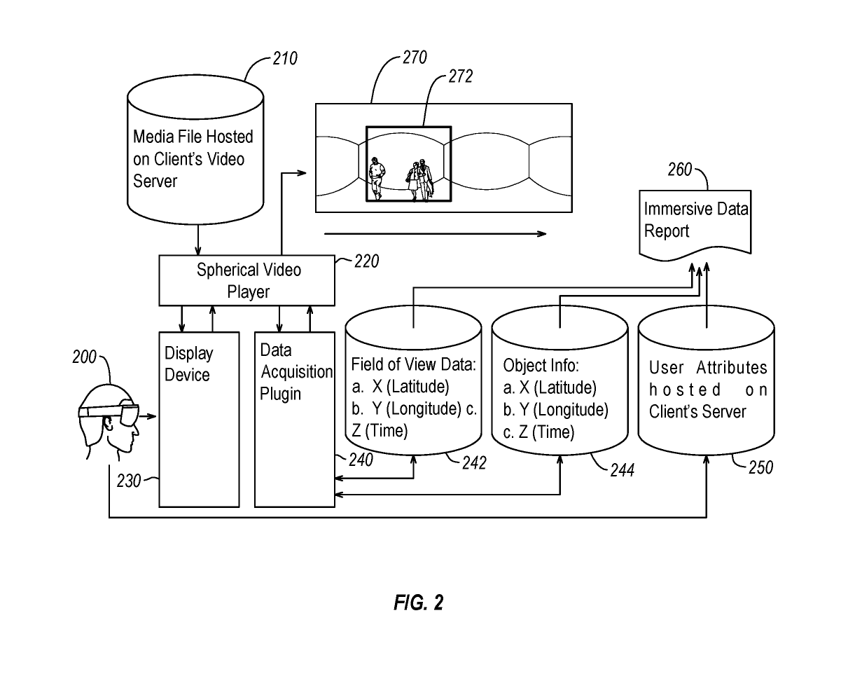

FIG. 2 illustrates a schematic of an embodiment of a spherical data acquisition system. As depicted in FIG. 2, a media file hosted on a video server 210 is streamed to a spherical video player 220. An exemplary spherical video file 270 may comprise a video file of a room. The room can be rendered as a virtual-reality environment to an end user through a display device 230.

In at least one embodiment, a data acquisition plugin 240 is also in communication with the spherical video player 220. The data acquisition plugin 240 is executable within the display device 230, within the client server, within the spherical video player 220, or within any other computing device. The spherical video is played to the user through a headset 200. The data acquisition plugin 240 is configured to gather various data about the virtual-reality environment and the end-user's interactions within the environment. For example, the data acquisition plugin 240 gathers information about the end user's field-of-view 242 within the virtual-reality environment and the location of specific elements (“products”) 244 within the virtual-reality environment. In at least one embodiment, the data acquisition plugin 240 also gathers user information and attributes 250.

As the various data points are gathered, the data acquisition plugin 240 identifies times when the user's field-of-view 272 (or an orientation vector extending from the user's field of view) includes the location of an element of interest. As used herein, the user's gaze includes the location of an element of interest (i.e., the hotspot) whenever a portion of the hotspot enters the user's field-of-view. As such, the user's gaze is considered to include the hotspot, even if the hotspot is only in the periphery of the field-of-view. In contrast, the user's gaze is considered to intersect with the hotspot whenever the user's gaze directly aligns with the hotspot, as determined by methods disclosed herein. In other words, the data acquisition plugin 240 determines when a user looked at the element of interest. As stated above, this analysis is performed by a plugin that can universally be added to a wide variety of different virtual reality machines. Accordingly, the data acquisition plugin 240 can generate immersive data reports 260 from a variety of different systems utilizing a variety of different types of virtual-reality environments.

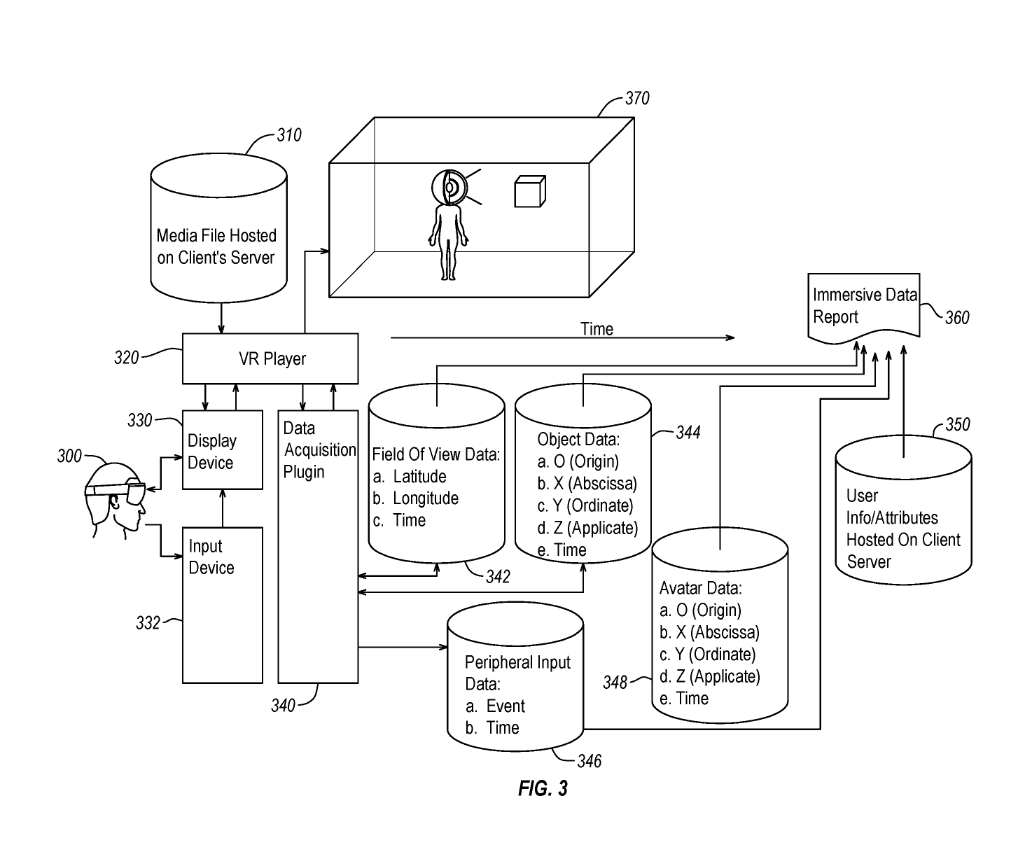

FIG. 3 illustrates a schematic of another embodiment of a virtual-reality system. Similar to FIG. 2, in FIG. 3 an end user with virtual-reality hardware 300 receives a media file from a server 310. The virtual-reality player 320 is in communication within the display device 330 (e.g., headset 300) and various input devices 332 (e.g., controllers). As such, the virtual-reality player 320 can respond to user actions within the virtual-reality environment 370.

The virtual-reality player 320 is in communication with a data acquisition plugin 340. The data acquisition plugin 340 is configured to gather information such as the field-of-view data 342 (also referred to herein as “view information”), the location of particular elements (objects) 344, the location of an end-user avatar 348 within the virtual-reality environment, and any peripheral input 346 from the end user. This information, along with user information 350, can be incorporated into an immersive data report 360 that indicates that user's interaction with the virtual-reality environment, including whether the user looked at a particular virtual element.

In at least one embodiment, the systems of FIG. 2 and FIG. 3 operate such that an end user can access a URL (or otherwise access a virtual-reality environment) within a virtual-reality display device (e.g., 230, 330). Accessing the URL causes the device to load a player and begin buffering visual frames. A data acquisition plugin (e.g., 240, 340) loads a coordinal map into the virtual-reality environment. In at least one embodiment, the coordinal map is not visible to the end user. Additionally, the various control and sensor aspects of the virtual-reality environment are initiated (accelerometers, gyroscopes, etc.).

Once the virtual-reality environment (e.g., 270, 370) is rendered to the end user, the virtual-reality system (e.g., 200, 300) monitors the end user for any inputs. For example, the end user may swivel his head causing an accelerometer and/or gyroscope to activate. Based upon the received sensor information, the virtual-reality environment adjusts such that the end user's actions are naturally reflected in the end user's virtual perspective. For example, when the end user moves his head, the end user's view of the virtual-reality environment may also correspondingly swivel.

Adjusting the user's perspective within the virtual-reality environment may comprise playing buffered video that corresponds with the desired view. Thus the user's movements cause different video segments to be displayed to the end user based upon the particular virtual-reality environment and the particular movements. In at least one embodiment, periodically the virtual reality system transmits data to an analytics engine (also referred to herein as “analytics platform interface”) for processing. The data may be transmitted to a local analytics plugin or may be transported to a remote location. In any case, as the user interacts with the virtual-reality environment, data can be gathered for analysis.

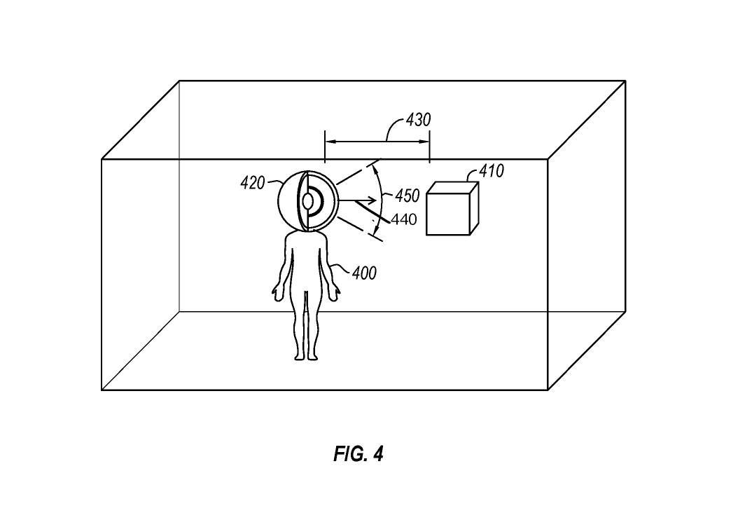

FIG. 4 illustrates a diagram depicting an embodiment of a virtual-reality processing method. In particular, FIG. 4 depicts a schematic of a method for determining an end user's gaze within a virtual-reality environment. Determining the end user's gaze may involve identifying a user's relative location within the virtual-reality environment. For example, a coordinate position within an x, y, and z coordinate system can be used to identify the location of the end user's avatar 400 within the virtual-reality environment.

Additionally, the system also determines the location of a virtual item (“object”) of interest 410 within the virtual-reality environment. The object's location can, similar to the end user's location, be determined by a coordinate position within an x, y, and z coordinate system. In at least one embodiment, within a virtual-reality environment, the object 410 is configured to move. In such a case, the system can be configured to continually recalculate the location of the object 410 within the virtual-reality environment and/or with respect to the user 400 (also referred to herein as the “avatar”). Accordingly, embodiments of the present invention can identify a distance 430 between the end user 400 and the object 410 based upon both a location associated with the end user 400 and a location associated with an object 410 within the virtual-reality environment.

In at least one embodiment, a coordinate system 420 is drawn around the head of the end user's avatar 400. For example, the coordinate system 420 may comprise a sphere that makes up a spherical coordinate system. The placement of the coordinate system 420 around the avatar's head creates a coordinate system around the field-of-view 450 of the end user's avatar 400. The end user's gaze is determined by identifying an orientation vector 440 that extends from the coordinate system 420 in the middle of the end user's field of view 450, as depicted in FIG. 4. A mathematical transform is used to map the orientation vector 440, with reference to the spherical coordinate system 420 around the user's head to the coordinate system of the virtual-reality environment. Once the mapping is complete, it can be determined whether the orientation vector 440 extending from the user's gaze intersected with a hotspot as defined by a coordinate location within the virtual-reality environment's coordinate system. Accordingly, a determination can be made about whether an end user gazed upon a particular virtual element of interest by determining if the orientation vector intersects with a hotspot that is associated with the element of interest.

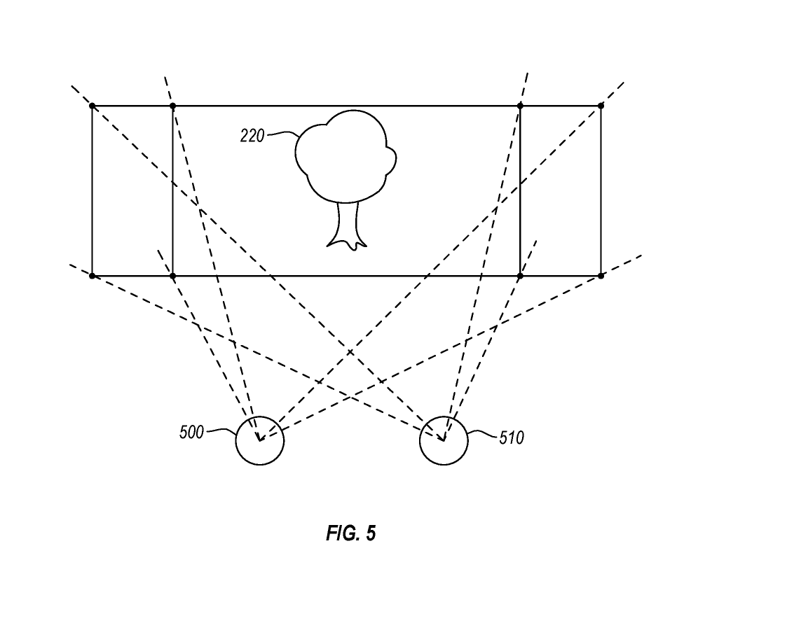

For example, FIG. 5 illustrates a diagram depicting another embodiment of a virtual-reality processing method. In particular, FIG. 5 depicts a schematic of an end user's avatar gazing at a tree 220 within the virtual-reality environment. In at least one embodiment, the tree 220 comprises an associated hotspot. An analytics engine identifies the location of the end user's avatar within the virtual-reality environment, including the end user's distance from the tree. The analytics engine also identifies the location of the tree within the virtual-reality environment. Further, the analytics engine generates one or more spheres around the avatar's head. In the depicted embodiment, instead of generating a single coordinate sphere, the analytics engine generates a sphere for each of the user's eyes. As such, the analytics engine is capable of tracking stereo vision within a virtual-reality environment. Orientation vectors can be drawn extending from each of the user's eyes 500, 510. A mathematical transform between the coordinate systems reveals whether the two orientation vectors intersect with a hotspot associated with the tree. The intersection can be stored within a database for later reporting.

For example, when tracking the field of view of both eyes it may be possible to more accurately determine the exact object that an end user is viewing. For instance, the end user may be viewing a virtual tree that is ten feet away, or a virtual tree along the same visual pathway that is one hundred feet away. Tracking both eyes may allow the analytic engine to more accurately identify an object of focus.

In at least one embodiment, tracking both eyes separately requires the use of two orientation vectors—one extending from the center of the field of view for each eye. Additionally, at least one embodiment requires the use of three coordinate systems, a first coordinate system for one eye, a second coordinate system for the other eye, and a virtual-reality environment coordinate system. Mathematical transforms can be utilized to map each respective coordinate system to the others, and thus using the method disclosed above, a user's gaze within the virtual-reality environment can be tracked.

In various embodiments, an analytics engine tracks the actual eyes of an end user or estimates an end user's gaze by calculating an orientation vector directly through the end user's field of view. The intersection of the orientation vector with a sphere positioned around the end user's avatar's head is logged for analysis. When the point of intersection with the sphere also represents a hotspot, based upon the location of an object of interest with respect to the avatar, the analytics engine determines that the user has gazed at the object of interest.

In at least one embodiment, time values are also stored with respect to the user's location and view. The time values may be useful in the case where the virtual-reality environment comprises a spherical movie or some other time discrete file. In other words, the virtual-reality environment may comprise a movie of a given length. During the movie, the end user may be able to look around and adjust his view, but the movie will end at a given time.

Storing a time associated with the user's location and view may allow additional data to be gathered. For example, it may be desirable to determine after the fact whether an end user gazed at a particular virtual element. This determination may be simple to make by simply accessing the time data associated with the end user's gaze, determining a particular time associated with the appearance of the element of interest in the virtual-reality environment, and determining whether the end user's gaze intersected with the element of interest. Accordingly, in at least one embodiment, hotspots can be added to a virtual-reality environment after the end user has finished viewing the environment. The analytics engine can then access data relating to the end user's coordinal location and gaze, along with various time stamps to determine if the end user viewed the element of interest. Additionally, the time information can be useful for determining how long an end user gazed at the element of interest.

Using the information generated by an analytics engine, disclosed embodiments can provide information relating to the visual “impressions” a user has with a particular hotspot. The information can comprise session time and duration, session content, user gaze and session behavioral data, number of times experienced by a user, geolocation of a user, video metadata, enriched user and device data, product hotspot metadata, tracking of hotspot engagement versus impressions or exposures. This information can provide significant insight into advertising within three-dimensional environments and into general three-dimensional design schemes.

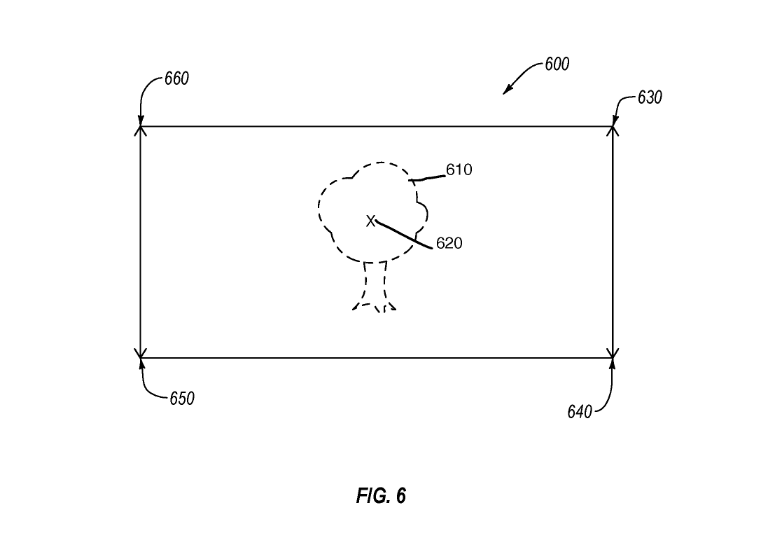

FIG. 6 depicts a user interface for a data acquisition system for a virtual-reality environment. The user interface 600 depicts a rendering of a virtual tree 610. In the depicted embodiment, in addition to generating one or more coordinate systems, the analytics engine also identifies various key coordinates with respect to the user's field-of-view. For example, in at least one embodiment, the analytics engine identifies the coordinates of each of the four corners (upper-right 630, upper-left 660, lower-right 640, lower-left 650) of the user's field of view. Additionally, the analytics engine also identifies a hitpoint 620 (or center point) of the user's field of view. Providing these coordinates with respect to the user's field-of-view presents an additional set of data, in addition to the coordinate systems, for tracking a user's gaze.

In at least one embodiment, the analytics engine derives the points by a generating plane at the intersection between the hitsphere and the camera axis at time zero. The analytics engine then computes four points, or nodes, with coordinates relative to a node that is associated with the camera. The four nodes 630, 640, 650, 660 are generated with respect to the device's aspect ratio. The four nodes 630, 640, 650, 660 are child nodes of the camera's node.

Once the nodes are created, the analytics engine can easily query for each node's local and global coordinates. In at least one embodiment, the local coordinates are always the same, while the global change as the camera node gets transformed. As such, the camera node is always looking at the center of the frame—this point is called the hitpoint.

Accordingly, in various embodiments the analytics engine uses the four nodes 630, 640, 650, 660 that defines the corners of the user's field-of-view and the reticle and/or the hitpoint to track the user's gaze. For example, the system can determine whether the user's gaze includes a hotspot by determining if a portion of the hotspot falls within the coordinate grid defined by the four nodes 630, 640, 650, 660. Similarly, the system can determine whether user's gaze intersects with the hotspot by determining if the hitpoint intersects with a portion of the hotspot. In some situations, the reticle and the hitpoint may slightly vary with regards to coordinates due to each of them being separately calculated. Providing both coordinates, however, allows the analytics engine to pick the coordinate that is the most useful for a given case.

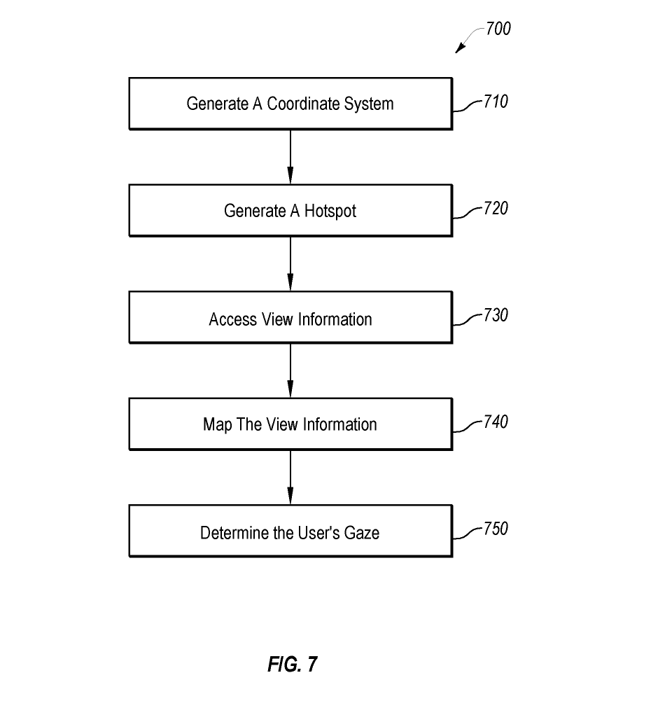

One will appreciate that embodiments disclosed herein can also be described in terms of flowcharts comprising one or more acts for accomplishing a particular result. For example, FIG. 7 and the corresponding text describe acts in various systems for tracking a user's visual focus within a virtual-reality environment. The acts of FIG. 7 are described below.

For example, FIG. 7 illustrates a flowchart 700 of acts associated with methods for tracking a user's visual focus within a virtual-reality environment. The illustrated acts comprise an act 710 of generating a coordinate system. Act 710 includes generating a user coordinate system within a virtual space. The user coordinate system is associated with a virtual sphere surrounding a location of a camera within the virtual space. For example, as depicted and described in FIG. 4 and the accompanying description, a spherical coordinate system 420 is generated around the head of a user's avatar.

Additionally, FIG. 7 illustrates that the method includes an act 720 of generating a hotspot. Act 720 comprises generating a hotspot within the virtual space. The hotspot comprises a hotspot coordinate associated with a virtual object and a pre-defined threshold of space surrounding the virtual object. For example, as depicted and described in FIG. 4 and the accompanying description, a hotspot 410 (also referred to as an object) is generated within the virtual-reality environment. The hotspot may be associated with a virtual item of interest.

FIG. 7 also illustrates that the method includes an act 730 of accessing view information. Act 730 comprises accessing view information received from one or more sensors integrated within an end user virtual reality hardware device. The view information relates to the direction of the user's gaze within the real-world. For example, as depicted and described in FIGS. 2, 3, and 4 and the accompanying description, a data acquisition plugin (also referred to more broadly as an analytics engine) gathers data from the virtual-reality environment. The gathered data includes data about the user's field-of-view, the user's location, the location of the hotspot, and various other related data.

Further, FIG. 7 illustrates that the method includes an act 740 of mapping the view information. Act 740 comprises mapping the view information to the user coordinate system. For example, as depicted and described in FIG. 4 and the accompanying description, various different coordinate systems can co-exist within the virtual reality environment. For example, the spherical coordinate plane around the head of the user's avatar indicates an intersection point of a reticle. Using mathematical transforms known in the art, the analytics engine can map the coordinate of the reticle to coordinates within the virtual-reality environment.

Further still, FIG. 7 illustrates that the method includes an act 750 of determining the user's gaze. Act 750 comprises determining, based upon the mapping, whether the user's gaze intersected with the hotspot. For example, as depicted and described in FIGS. 4 and 9 and the accompanying description, the analytics engine is capable of determining if a reticle associated with the user's gaze of a hitpoint intersects with a hotspot.

Embodiments disclosed herein provide significant improvements to technical challenges within the field of virtual reality. In particular, disclosed embodiments provide systems and methods for determining whether a user gazed at or were exposed to particular objects within the virtual-reality environment. Disclosed systems can make the determination in real-time as the user is viewing the virtual-reality environment or after the fact, based upon data that was gathered during the viewing. As such, disclosed embodiments provide solutions to technical problems that are unique to virtual-reality environments where a user may only view a small fraction of the total virtual-reality content.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A computer system for tracking a user's gaze within a virtual-reality environment comprising:
one or more processors; and
one or more storage devices having stored thereon computer-executable instructions that are executable by the one or more processors, and that configure the system to track the user's gaze within the virtual-reality environment, including computer-executable instructions that configure the computer system to perform at least the following:
generate a virtual-reality environment coordinate system within a virtual space;
generate a hotspot within the virtual space, wherein the hotspot comprises a hotspot coordinate associated with a virtual object and a pre-defined threshold of space surrounding the virtual object;
access view information, received from one or more sensors integrated within an end user virtual reality hardware device, wherein the view information relates to the direction of the user's gaze within the real-world;
map the view information to the environment coordinate system; and
determine, based upon the mapping, whether the user's gaze included the hotspot.

2. The computer system as recited in claim 1, wherein the virtual-reality environment coordinate system comprises:
an X coordinate that is defined as the latitudinal value;
a Y coordinate that is defined as the longitudinal value;
a D coordinate that is defined as a distance value of the viewer from a virtual element in the virtual three-dimensional environment;
a T1 coordinate that is defined as a virtual time; and
a T2 coordinate that is defined as a real time.

3. The computer system as recited in claim 1, further comprising computer-executable instructions that are executable by the one or more processors to:
generate a user coordinate system within a virtual space, wherein the user coordinate system is associated with a virtual sphere surrounding a location of a camera within the virtual space; and
calculate a view reticle that extends from the center of the user's field-of-view and intersects with a reticle coordinate on the virtual sphere.

4. The computer system as recited in claim 3, wherein the user coordinate system comprises a spherical and/or Cartesian coordinate system in three-dimensional space relative to the current origin, which is the user position, and time logs for both real and environment time.

5. The computer system as recited in claim 3, further comprising computer-executable instructions that are executable by the one or more processors to:
calculate a set of four coordinates that respectively define the locations of corner pixels at each corner of the user's field-of-view.

6. The computer system as recited in claim 5, further comprising computer-executable instructions that are executable by the one or more processors to:
calculate a field-of view dataset, wherein the field-of-view dataset comprises a set of four coordinates that respectively define the locations of the pixels at each corner of the user's field-of-view.

7. The computer system as recited in claim 6, wherein the field-of-view dataset comprises a hitpoint coordinate that defines the center of the user's field-of-view.

8. The computer system as recited in claim 6, wherein the reticle coordinate and the field-of-view dataset are updated concurrently in parallel.

9. The computer system as recited in claim 8, further comprising computer-executable instructions that are executable by the one or more processors to determine that the user's gaze intersected the hotspot by determining that the reticle coordinate mapped to a pixel associated with the hotspot.

10. The computer system as recited in claim 8, further comprising computer-executable instructions that are executable by the one or more processors to determine that the user's gaze intersected the hotspot by determining that the hitpoint coordinate mapped to a pixel associated with the hotspot.

11. A computer-implemented method for tracking a user's visual focus within a virtual-reality environment comprising:
generating a user coordinate system within a virtual space, wherein the user coordinate system is associated with a virtual sphere surrounding a location of a camera within the virtual space;
generating a hotspot within the virtual space, wherein the hotspot comprises a hotspot coordinate associated with a virtual object and a pre-defined threshold of space surrounding the virtual object;
accessing view information, received from one or more sensors integrated within an end user virtual reality hardware device, wherein the view information relates to the direction of the user's gaze within the real-world;
mapping the view information to the user coordinate system; and
determining, based upon the mapping, whether the user's gaze intersected with the hotspot.

12. The method as recited in claim 11, further comprising:
generating a view reticle that comprises an orientation vector that extends from a middle of the user's field of view and intersects at a reticle coordinate with the user coordinate system; and
updating a reticle dataset that comprises both a spherical coordinate set and a coordinate set that describes a point where the view reticle intersects with the user coordinate system.

13. The method as recited in claim 12, further comprising:
calculating a set of four coordinates that respectively define the locations of corner pixels at each corner of the user's field-of-view.

14. The method as recited in claim 13, further comprising computer-executable instructions that are executable by the one or more processors to:
calculate a field-of view dataset, wherein the field-of-view dataset comprises a set of four coordinates that respectively define the locations of the pixels at each corner of the user's field-of-view.

15. The method as recited in claim 14, wherein the field-of-view dataset comprises a hitpoint coordinate that defines the center of the user's field-of-view.

16. The method as recited in claim 14, wherein the reticle coordinate and the field-of-view dataset are updated concurrently in parallel.

17. The method as recited in claim 12, further comprising determining that the user's gaze intersected the hotspot by determining that the reticle coordinate mapped to a pixel associated with the hotspot.

18. The method as recited in claim 11, wherein hotspot coordinate is associated with a different coordinate system than the user coordinate system.

19. The method as recited in claim 11, wherein the virtual-reality environment comprises a spherical video.

20. A computer system for tracking a user's gaze within a virtual-reality environment comprising:
one or more processors; and
one or more storage devices having stored thereon computer-executable instructions that are executable by the one or more processors, and that configure the system to track the user's gaze within the virtual-reality environment, including computer-executable instructions that configure the computer system to perform at least the following:
generate a user coordinate system within a virtual space, wherein the user coordinate system is associated with a virtual sphere surrounding a location of a camera within the virtual space;
generate a hotspot within the virtual space, wherein the hotspot comprises a hotspot coordinate associated with a virtual object and a pre-defined threshold of space surrounding the virtual object;
access view information, received from one or more sensors integrated within an end user virtual reality hardware device, wherein the view information relates to the direction of the user's gaze within the real-world;
map the view information to the user coordinate system; and
determine, based upon the mapping, whether the user's gaze intersected with the hotspot.
